(19) United States
(12) Patent Application Publication
(10) Pub. No.: US 2023/0309613 A1
(43) Pub. Date: Oct. 5, 2023

(54) A Cartridge for a Vapour Generating System

(71) Applicant: JT International SA, Geneva (CH)

(72) Inventor: Hee Khiem Tan, Butterworth (MY)

(73) Assignee: JT International SA, Geneva (CH)

(21) Appl. No.: 18/020,208

(22) PCT Filed: Aug. 9, 2021
(86) PCT No.: PCT/EP2021/072135

§ 371 Date: Feb. 7, 2023

(30) Foreign Application Priority Data
Aug. 10, 2020 (WO) PCT/CN2020/108280

(51) Int. Cl. A24F 40/42; A24F 40/10; A24F 40/44; A24F 40/46; A24F 40/70; H05B 3/06

(52) U.S. Cl. CPC A24F 40/42; A24F 40/10; A24F 40/44; A24F 40/46; A24F 40/70; H05B 3/06; H05B 2203/016

(57) ABSTRACT

A tamper-resistant cartridge for a vapour generating system includes a housing and a closure secured to the housing. A wick or other liquid transport element is secured inside the housing. A heating element located inside the housing is attached to the closure and also engages the wick so that removal of the closure from the housing causes displacement of the heating element. This results in damage to the wick and/or the heating element so that the cartridge becomes unusable. The attachment of the heating element to the closure may be via terminal wires of the heating element, which pass through apertures in the closure and are joined to electrodes on an exterior surface of the closure.

### DESCRIPTION

### Technical Field

The present disclosure relates generally to a cartridge for a vapour generating system configured to heat a liquid to generate a vapour which cools and condenses to form an aerosol for inhalation by a user of the system. The present disclosure also relates to a vapour generating system that comprises a vapour generating device and a cartridge configured to be used with the vapour generating device.

### Background

The term vapour generating system (or more commonly electronic cigarette or e cigarette) refers to handheld electronic apparatus that is intended to simulate the feeling or experience of smoking tobacco in a traditional cigarette. Electronic cigarettes work by heating a vapour generating liquid to generate a vapour that cools and condenses to form an aerosol which is then inhaled by the user. Accordingly, using e-cigarettes is also sometimes referred to as “vaping”. The vapour generating liquid may, for example, comprise polyhydric alcohols and mixtures thereof such as glycerine or propylene glycol. The vapour generating liquid may contain nicotine.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

Typical e-cigarette vaporizing units, i.e. systems or sub-systems for vaporizing the vapour generating liquid, utilize a heating element to produce vapour from liquid stored in a capsule, tank or reservoir. When a user operates the e-cigarette, liquid from the reservoir is transported through a liquid transport element, e.g. a cotton wick or a porous ceramic block, and is heated by the heating element to produce a vapour, which cools and condenses to form an aerosol that can be inhaled. To facilitate the ease of use of e cigarettes, removable cartridges are often employed. These cartridges are often configured as “cartomizers”, which means an integrated component comprising a liquid store, a liquid transport element and a heater. Electrical connectors may also be provided to establish an electrical connection between the heating element and a power source.

Such cartridges may be disposable, i.e. not intended to be capable of reuse after the supply of liquid in the reservoir has been exhausted. Alternatively, they may be reusable, being provided with means allowing the reservoir to be refilled with a new supply of vapour generating liquid. Particularly in the case of disposable cartridges, it is desirable to reduce the number and complexity of their components, thereby reducing waste and making the manufacturing process simpler and cheaper. It is also desirable that disposable cartridges should be tamper-resistant, i.e. it should be difficult or impossible for a user to refill them when the original vapour generating liquid has been exhausted. The replacement liquid of unknown composition may be dangerous in itself or may fail to work safely and reliably when used in a cartridge that was not designed for it. Moreover, a cartridge that has been designed to be used once may not continue to work safely and reliably when it is repeatedly refilled and reused over an indefinite period.

A cartridge for an e-cigarette typically comprises an air inlet at a first end and an air outlet at a second, opposite end. (Considered from the viewpoint of a user of the system, the first end of the cartridge may also be termed the distal end and the second end of the cartridge may also be termed the proximal end or mouth end.) The first end of the cartridge is configured to be releasably connected to the vapour generating device, which may, for example, contain a power source and control electronics. A user inhales through a mouthpiece at the second end of the cartridge to draw air along an airflow path from the air inlet to the air outlet. The airflow path passes through a vaporization chamber, where liquid vaporized by the heating element mixes with the air. The vapour cools as it passes from the vaporization chamber towards the air outlet and at least partly condenses into small droplets that form an aerosol in the stream of inhaled air.

Droplets from the aerosol may impact and adhere to the walls of the vaporization chamber or other parts of the airflow path. Some vaporized liquid may also re-condense directly on the cooler walls. As the droplets accumulate on the walls, they may coalesce to form a mobile liquid that can flow under the influence of gravity or the moving air towards the air inlet or air outlet. Further, some liquid in the vaporization chamber may fail to vaporize and instead accumulate in the chamber, from where it can flow in a similar way towards the air inlet or air outlet. It is undesirable that such liquid should be permitted to leak from the air inlet or air outlet to the exterior of the vapour generating system, where it may be unsightly, risk causing stains or otherwise be unacceptable to the user. Additionally or alternatively, the leaked liquid may find its way into the power source or the control electronics of the vapour generating device and cause damage.

### SUMMARY OF THE INVENTION

The invention provides a cartridge for a vapour generating system, the cartridge comprising: a housing; a closure secured to the housing; a liquid transport element secured inside the housing; and a heating element located inside the housing; wherein the heating element is attached to the closure such that removal of the closure from the housing causes displacement of the heating element; and wherein the heating element engages the liquid transport element such that displacement of the heating element causes damage to the liquid transport element or to the heating element.

The invention further provides a method of manufacturing a cartridge for a vapour generating system, the method comprising the steps of:
engaging a heating element with a liquid transport element;
securing the liquid transport element inside a housing and locating the heating element inside the housing such that displacement of the heating element must cause damage to the liquid transport element or to the heating element;
securing a closure to the housing; and
attaching the heating element to the closure such that removal of the closure from the housing causes displacement of the heating element.

The cartridge is thus tamper-resistant because in order to refill the cartridge the closure must be removed; but removal of the closure causes damage to the liquid transport element or to the heating element (or both). Therefore a cartridge refilled in this way would no longer be operable. By “damage” is meant a change in the physical state of an element that prevents it from carrying out its function. The change is preferably impossible or at least impractical to undo. The damage may include rupture of the element so that, for example, the heating element can no longer carry electrical current or the liquid transport element can no longer transport liquid effectively. Alternatively, the damage may include deformation of the element that prevents the closure from being re-attached to the housing.

The heating element or the liquid transport element may be designed to undergo damage in a particular way, for example by including a weak point at which the heating element will rupture before sufficient force is applied to detach the fluid transport element from the housing. Alternatively, the mounting of the fluid transport element in the housing may be designed such that, once it has been detached, it is impossible or impractical to replace when the only access results from the closure having removed.

In a preferred embodiment of the invention, the heating element comprises two electrical terminals and the closure comprises two electrodes, the terminals of the heating element being attached to the electrodes of the closure. When the cartridge is coupled to a vapour generating device, the electrodes of the closure provide contacts for a supply of electric current from a power source in the vapour generating device to flow through the heating element. If the terminals of the heating element are only just long enough to reach the electrodes, then any force applied to remove the closure will be transmitted through the terminals to the heating element and any displacement of the closure will result in displacement of the heating element. Because the heating element is engaged with the liquid transport element, damage to one or both of those elements must result when heating element is displaced but the liquid transport element remains secured to the housing.

The terminals of the heating element are preferably welded or soldered to the electrodes of the closure. For example, they may be laser welded. This prevents a possible alternative result of removing the closure, namely that the terminals might become detached from the closure.

In some preferred embodiments of the invention, the heating element passes through the liquid transport element. For example, the liquid transport element may be a wick formed of cotton or another textile material, while the heating element is a wire that passes through the wick. In this case, the wick is likely to be relatively fragile and to suffer damage if both ends of the wire are pulled by a tensile force applied to the terminals. Alternatively, the liquid transport element may be a porous ceramic block, through which a wire of the heating element passes. In this case, damage to the heating element is more likely to result if a tensile force is applied to its ends.

In other preferred embodiments of the invention, the heating element wraps around the liquid transport element. For example, the heating element may be a helical wire coil that wraps around a cylindrical wick or ceramic block.

Other types of engagement are envisaged within the scope of the invention. For example, the heating element may be in the form of a conductive trace laid down on the surface of a ceramic liquid transport element. In this case, the heating element is likely to be relatively fragile and will be ruptured if a tensile force is applied to the terminals.

If the final step in the manufacturing process of the cartridge were to apply the closure to an otherwise complete assembly, then it is likely that that step could simply be reversed to remove the closure without causing damage to the heating element and/or the liquid transport element. Such an outcome would be contrary to the present invention. One solution to this problem, according to a preferred embodiment of the invention, is that the two electrodes are on a distal surface of the closure; at least one aperture extends through the closure from the distal surface to a proximal surface of the closure; and the terminals of the heating element extend through the at least one aperture of the closure. With this arrangement, the terminals project through the apertures to the exterior of the cartridge so the final manufacturing step can be to attach the terminals irreversibly to the electrodes from the exterior. A preferred method of attachment is welding, particularly laser welding. Welding attaches the terminals securely and the weld can effectively fill the apertures to prevent them being a conduit for possible leakage of liquid from the interior to the exterior of the cartridge.

Although the two terminals may share a single aperture through the closure, it is preferred that the closure should comprise two apertures formed respectively in the two electrodes; wherein the two terminals of the heating element extend respectively through the two apertures. Thus each terminal naturally couples to its respective electrode and, if the arrangement is symmetrical, then a central space in the closure between the two electrodes becomes free for the location of a cartridge air inlet.

In a preferred embodiment of a cartridge according to the invention, the housing comprises a reservoir secured to a reservoir cover. The closure of the cartridge may in tum be secured to the reservoir cover. Such a three-part cartridge is a convenient arrangement for the easy assembly and filling of the cartridge during its manufacturing process. Preferably, the reservoir is irreversibly secured to the reservoir cover, for example by ultrasonic welding, to create an air- and liquid-tight seal between the two parts and to increase the tamper-resistance of the cartridge.

The aspect of the invention, whereby the terminals of the heating element extend through apertures in the closure for external attachment to the electrodes, may be adopted as a convenient apparatus and method for manufacturing it, independently of the tamper-resistance aspect of the invention. Accordingly, the invention further provides a cartridge for a vapour generating system, the cartridge comprising: a housing; a closure secured to the housing, the closure comprising two electrodes on a distal surface of the closure and at least one aperture that extends through the closure from the distal surface to a proximal surface of the closure; and a heating element located inside the housing, the heating element comprising two electrical terminals; wherein the terminals of the heating element extend through the at least one aperture of the closure and are attached to the electrodes of the closure.

The invention also provides a method of manufacturing a cartridge for a vapour generating system, the method comprising the steps of:
positioning a heating element inside a housing, the heating element comprising two electrical terminals;
securing a closure to the housing, the closure comprising two electrodes on a distal surface of the closure and at least one aperture that extends through the closure from the distal surface to a proximal surface of the closure; and
passing the terminals of the heating element through the at least one aperture in the closure and attaching the two terminals respectively to the two electrodes.

Finally, the invention further provides a vapour generating system, which comprises a vapour generating device releasably coupled to a cartridge as previously described.

### BRIEF DESCRIPTION OF THE DRAWINGS

FIG. 1 is an exploded perspective view of a cartridge that is useful for understanding the present invention.

FIG. 2 is a perspective view of the cartridge of FIG. 1 when assembled.

FIGS. 3 to 6 are perspective views, partially in section on the plane of the axis, that show examples of engagement between a heater element and a liquid transport element according to the invention.

FIG. 7 is a schematic diagram of a vapour generating system that comprises a cartridge according to the present invention.

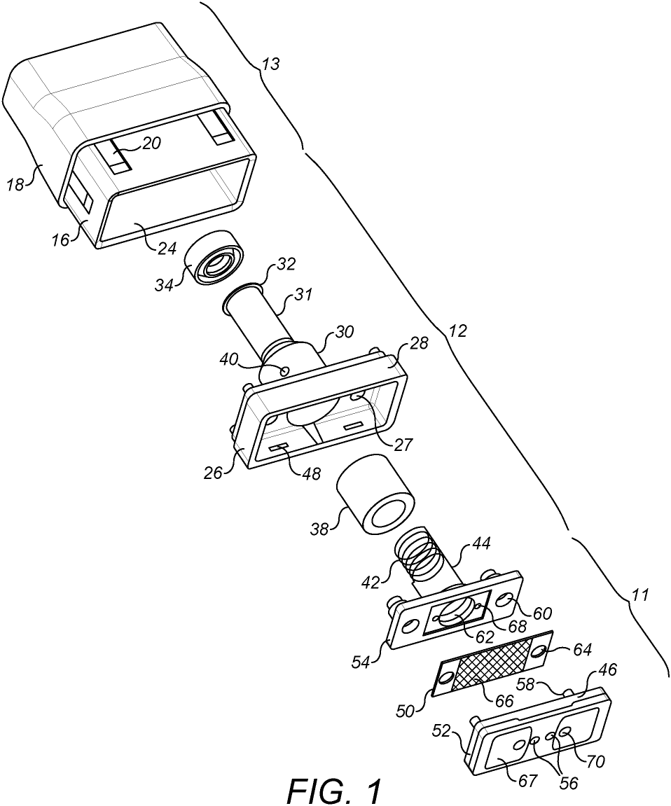

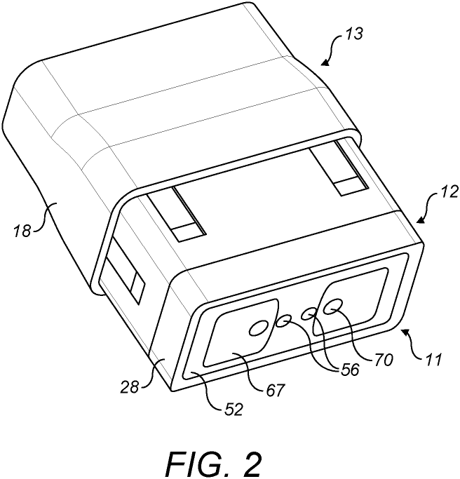

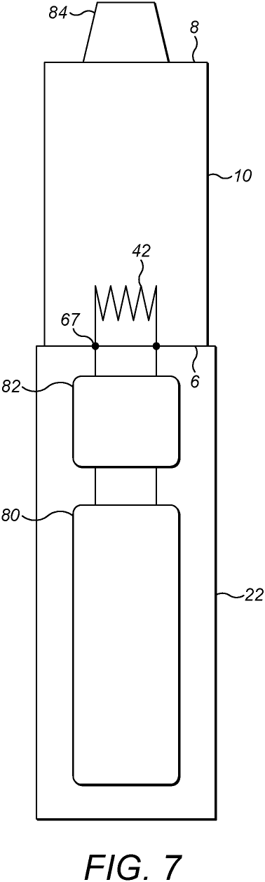

The cartridge 10 comprises three main parts. They will be described in more detail below but, in general terms, a first part 11 serves as a cartridge closure assembly, a second part 12 provides heating and vaporization apparatus and a third part 13 holds a store of a vapour generating liquid and provides a mouthpiece. The three-part configuration of the cartridge 10 is a convenient arrangement for the easy assembly and filling of the cartridge during its manufacturing process. It can be seen from FIG. 1 that the parts can be assembled by inserting them in sequence along the longitudinal axis of the cartridge 10 to arrive at an assembled cartridge with the appearance shown in FIG. 2. This design keeps the number of components of the cartridge small and facilitates sealing between the parts to reduce the risk of air or liquid leaking between them during use.

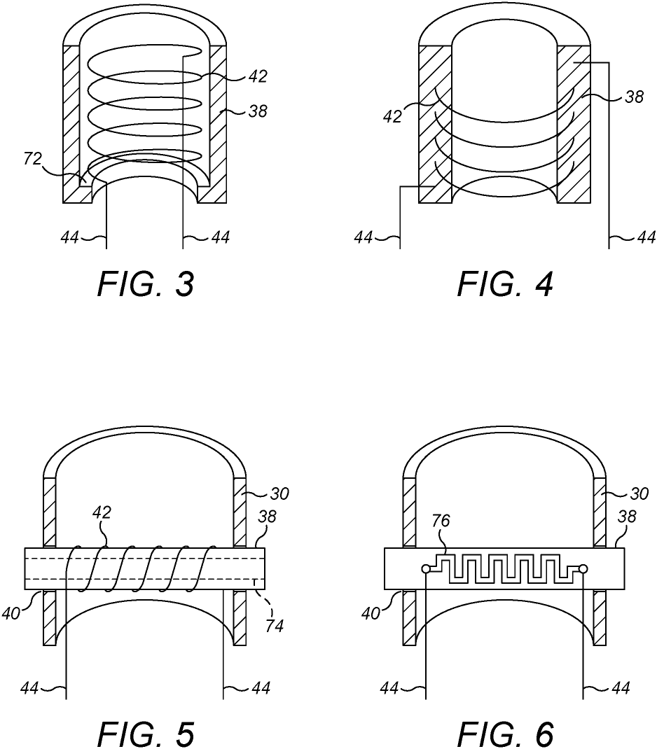

The third part 13 of the cartridge 10 comprises a housing 16, which may be moulded as a single piece from a plastic material such polycyclohexylenedimethylene terephthalate glycol (PCT-G). An external wall 18 of the housing 16 forms the exterior of the assembled cartridge 10 at its proximal end. In the proximal end face of the housing 16 (hidden from view in the drawings) there is an aperture that serves as a conventional mouthpiece, through which a user of the e-cigarette can draw air through the device. The exterior of the housing 16 also provides means 20 for retaining the cartridge 10 when it is attached to a vapour generating device 22 as shown schematically in FIG. 3. The retaining means may include any suitable means for retention, for example friction pads, clips, magnets or – in alternative, cylindrical embodiments – a screw thread or bayonet fitting. An interior of the housing 16 forms a tank or reservoir 24 for storing a vapour generating liquid. A distal end of the reservoir 24 is open to allow the reservoir to be filled with the liquid and to allow the second part 12 to be inserted.

The second part 12 of the cartridge 10 comprises a reservoir cover 26 a proximal wall 27 of which covers the distal opening of the reservoir 24 when the second and third parts 12,13 of the cartridge 10 are assembled together. The second and third parts 12,13 may be ultrasonically welded to one another to ensure an air- and water-tight seal between them and to prevent the reservoir 24 being re-opened by a user, e.g. to re-fill it if the cartridge is not intended to be reusable. Side walls 28 of the reservoir cover 26 form part of the exterior of the assembled cartridge 10 near its distal end. They also provide a seat for the first part 11 of the housing 10 as described below.

An aperture in the proximal wall 27 of the reservoir cover 26 opens into a vaporization chamber 30, which in the illustrated cartridge is in the form of an axially aligned cylinder. Other shapes of the vaporization chamber 30 are possible. The reservoir cover 26 and the vaporization chamber 30 may be moulded as an integral part or may, as shown, be formed by the attachment of two components in a pre-assembly step. That allows the two components to be formed from different materials, for example the reservoir cover may be moulded from a plastic such as PCT-G, while the vaporization chamber 30 may be formed from stainless steel, which is able to withstand higher temperatures. The vaporization chamber 30 is located within the reservoir 24. A proximal end of the vaporization chamber 30 is coupled to a cylindrical tube 31 that has a smaller diameter than the vaporization chamber 30. The tube 31 extends in the proximal direction through the reservoir 24 so that an air outlet 32 at the end of the tube 31 is located adjacent to the mouthpiece. A sealing gasket 34, for example of silicone rubber, couples the air outlet 32 to the mouthpiece, while sealing around the mouthpiece to prevent liquid leaking from the reservoir 24 to the mouthpiece.

The cylindrical vaporization chamber 30 can accommodate a hollow, cylindrical liquid transport element 38. The liquid transport element 38 is permeable to the liquid and may comprise, for example, a ceramic core or a wick formed from a textile material such as cotton. One or more – preferably two or more – openings 40 pierce the side walls of the vaporization chamber 30 but are occluded by the liquid transport element 38. Vapour generating liquid from the reservoir 24 can therefore pass through the openings 40 into the vaporization chamber 30 only by diffusing through the material of the liquid transport element 38, which thereby serves to regulate the flow of the liquid and to distribute it along and around the interior of the vaporization chamber 30.

The second part 12 of the housing 10 further comprises a heating element, which in the illustrated cartridge is in the form of an axially aligned, cylindrical heater coil 42. Two wires 44 extend in the distal direction from the ends of the coil to serve as electrical terminals, through which electric current may be delivered to the coil 42. In other designs of cartridge, the heater may take other forms. For example, it may be an electrically connected, resistive element of a different shape or orientation; an electrical trace laid down on a surface in the vaporization chamber 30, such as the surface of a ceramic liquid transport element 38.

The illustrated heater coil 42 fits inside the liquid transport element 38 so that, when operated, it raises the temperature of the inner surface of the liquid transport element 38. The raised temperature causes liquid that has diffused through the element 38 to vaporize from its surface into a stream of air passing through the vaporization chamber 30 to the tube 31. As the air flows along the tube 31, the vapour cools and condenses into small droplets suspended in the airstream, thereby forming an aerosol that can be inhaled by the user through the mouthpiece. Some droplets may also condense or impact on the walls of the tube 31 or the vaporization chamber 30. The droplets of liquid may coalesce and flow towards the air inlet or the air outlet 32, giving rise to a risk that liquid may leak to the exterior of the device.

The distal end of the cartridge 10 is formed by the first part 11, which serves as a cartridge closure assembly. The first part 11 fits into the distal end of the second part 12 and is retained, for example, by lugs 46 on the first part 11 that snap into recesses 48 in the side walls 28 of the reservoir cover 26 of the second part 12, or by any other suitable means. Preferably, the first part 11 is designed to be difficult for a user to remove from the second part 12, in order to prevent tampering with the device.

The cartridge closure assembly comprises a layer of mesh 50, which is sandwiched between a cartridge cover 52 and a gasket 54. When the cartridge 10 is assembled, the cartridge cover 52 forms the exterior surface of the cartridge at its distal end. The cartridge cover 52 comprises an air inlet 56, which admits air into the distal end of an airflow path that passes through the vaporization chamber 30 and the tube 31 to the air outlet 32 and the mouthpiece at the proximal end of the cartridge 10. In the illustrated cartridge 10, the air inlet 56 comprises a pair of apertures close to the centre of the distal face of the cartridge cover 52 but it may take many other forms. When the cartridge is attached to a vapour generating device 22, the air inlet 56 may receive air via supply channels (not illustrated) in the vapour generating device, the arrangement of which may dictate the form and position of the air inlet 56.

The cartridge cover 52 comprises a pair of posts 58 that extend from its proximal surface and are received in a corresponding pair of holes 60 in the gasket 54 to secure the cartridge cover 52 and the gasket 54 together. The gasket comprises a central opening 62 aligned with the air inlet 56 to provide part of the airflow path from the air inlet 56 to the vaporization chamber 30. The layer of mesh 50 is sandwiched between the cartridge cover 52 and the gasket 54 and is clamped tightly between them. The mesh layer 50 may also be provided with a pair of holes 64, which receive the posts 58 of the cartridge cover 52 and ensure that the mesh layer 50 is correctly located and secured. As illustrated, the mesh layer 50 need not comprise a mesh structure 66 over its entire area; for example, the layer 50 may be continuous in the area surrounding the holes 64 in order to better define the holes 64 and locate the mesh layer 50 more securely. However, the mesh layer 50 should comprise a mesh structure 66 over at least the area aligned with the air inlet 56 and the gasket opening 62, in order that air drawn along the airflow path can pass from the air inlet 56 through the mesh structure 66 and the gasket opening 62 to the vaporization chamber 30. As previously described, the average pore size of the mesh structure 66, the proportion of the area of the mesh structure 66 occupied by pores, and the surface material of the mesh structure 66 all combine to resist the flow of liquid in the opposite direction to the airflow, namely from the vaporization chamber 30 to the air inlet 56. It may be noted that the inwardly flowing air can also help to oppose the outward flow of liquid through the mesh layer 50. In the illustrated cartridge, the mesh layer 50 is formed from stainless steel with a coating of PTFE. The average pore size of the mesh structure is approximately 10 µm.

When the first part 11 comprising the cartridge closure assembly is inserted into the second part 12 comprising the reservoir cover 26, the central opening 62 of the gasket 54 opens into the vaporization chamber 30. The gasket 54 is preferably formed from a resilient material such as silicone rubber in order to seal around the distal end of the vaporization chamber 30 and prevent air or liquid leaking between the first and second parts 11,12. A proximal surface of the gasket 54 may also be shaped to provide a seat for the heater coil 42.

The cartridge cover 52 comprises a pair of electrodes 67 exposed on its distal surface, which provide contacts for the vapour generating device to supply current to the heater coil 42. The cartridge cover 52 has been formed by insert moulding a plastic body around the two electrodes 67. A pair of small apertures 68 in the gasket 54 allow the terminal wires 44 of the heater coil 42 to pass through the gasket 54 and make electrical contact with the electrodes 67. The mesh layer 50 may similarly be provided with small apertures (not illustrated) for the heater terminal wires 44 to pass through, or it may be possible simply to push the wires 44 through the mesh structure 66 of the mesh layer 50. In the illustrated cartridge 10, the electrodes 67 are also provided with respective apertures 70 for the heater terminal wires 44 to pass through, so that the terminal wires 44 may be welded or soldered to the electrodes 67 from the exterior of the cartridge 10 as a final step after assembly of the cartridge. Alternatively, the terminal wires – suitably insulated from one another – could pass through a single, common aperture in the cartridge closure assembly, before diverging at its distal face to be attached to the respective electrodes 67.

The terminal wires 44 of the heating element 42 are parallel to the axis of the cartridge 10 and are just long enough to reach the electrodes 67 without significant play. The wires 44 may be manufactured to the required length or may be trimmed after assembly of the cartridge closure assembly 11 with the reservoir cover 26. Accordingly, if an attempt is made to remove the cartridge closure assembly 11, for example by levering the lugs 46 out of the recesses 48, any movement of the cartridge closure assembly 11 exerts tension on the terminal wires 44. The tension tends to pull the heating element 42 away from the liquid transport element 38. In accordance with the present invention, the liquid transport element 38 is secured inside the housing 16 and is also engaged with the heating element 42 such that displacement of the heating element 42 will cause damage to the liquid transport element 38 or to the heating element 42 (or both). However, that is not shown in FIG. 1. In that illustration, applying a tensile force to the two terminal wires 44 would simply cause the heater coil 42 to slide axially out of the cylindrical liquid transport element 38 or would cause the liquid transport element 38 to slide axially out of the vaporization chamber 30. FIGS. 3 to 6 schematically show some examples of how the second part 12 of the cartridge 10 could be adapted from FIG. 1 to embody the present invention.

In FIG. 3, the distal end of the liquid transport element 38 is provided with an inwardly directed flange 72, which serves as a seat to retain the heater coil 42 against being pulled in the distal direction by tension applied to the heater terminal wires 44. If sufficient tensile force is applied to pull the coil through the reduced radius opening of the flange 72, the coil 42 will be deformed and damaged to such an extent that it cannot thereafter be reinserted and operate to heat the surface of the liquid transport element 38 effectively. It will be understood that this arrangement requires the heater coil 42 to be pre-assembled in the “cup” formed by the liquid transport element 38 before the liquid transport element 38 is inserted in the vaporization chamber 30.

FIG. 4 shows an alternative arrangement, in which the heater coil 42 has been embedded in the liquid transport element 38 during formation of the liquid transport element 38 so that it cannot be removed without causing damage that would make the cartridge unusable.

FIGS. 3 and 4 do not show any means for retaining the liquid transport element 38 in the vaporization chamber 30 against an axial force that may be applied to it. Any suitable mechanical restraint may be used for this purpose, for example a clip on the reservoir cover 26 or a transverse pin that passes through both the vaporization chamber 30 and the liquid transport element 38. Other suitable means to secure the liquid transport element 38 in the vaporization chamber 30 include a screw or bayonet coupling.

In FIG. 5, the liquid transport element 38 is a cylinder that, instead of being aligned with the axis of the cartridge 10 as in FIG. 1, is disposed transversely to the axis and extends through the two opposing side openings 40 of the vaporization chamber 30. The liquid transport element 38 may be a solid cylinder, whereby liquid from the reservoir 24 diffuses along its length from the two ends. More preferably, the liquid transport element 38 is a hollow cylinder, whereby liquid from the reservoir 24 can flow into a central bore 74 of the cylinder then diffuse outwards through the thickness of the cylinder to reach the outer surface of the liquid transport element 38. The heater coil 42 is wrapped in a helical configuration around the outer surface of the liquid transport element 38. It is immediately apparent that exerting tension on the terminal wires 44 cannot remove the heater coil 42 from the liquid transport element 38 or remove the liquid transport element 38 from its mounting in the vaporization chamber 30 without causing irreversible damage.

FIG. 6 illustrates a similar arrangement to FIG. 5, except that instead of a coil wrapped around the liquid transport element 38, the heating element is formed by a flat, conductive trace 76 laid down on the surface the liquid transport element 38. In order to receive such a trace 76, the liquid transport element 38 in this example is preferably a porous ceramic block. The liquid transport element 38 may again be cylindrical or a prism of square or other cross section. The configuration of the trace 76 is shown purely schematically: in practice it preferably extends over the majority of the surface of the liquid transport element 38. If a tensile force is applied to the terminal wires 44, they are like to detach from the conductive trace 76 or tear it away from the surface of the liquid transport element 38, causing irreversible damage.

FIG. 73 schematically shows one possible configuration of a vapour generating system in accordance with the present invention. A vapour generating device 22 houses a power source 80, which provides power to a control circuit 82. The distal end of a cartridge 10 is releasably connected to the vapour generating device 22. There is a mouthpiece 84 at the proximal end of the cartridge 10, which may be attached to or integral with the cartridge 10. Electrodes 67 couple the power source 80, via the control circuit 82, to a heater 42 in the cartridge 10. Although the cartridge 10 and vapour generating device 22 are shown connected in an end-to-end configuration, it will be understood that in alternative embodiments of the invention the cartridge 10 could be releasably inserted inside the housing of the vapour generating device 22. In that case, the mouthpiece 84 could be attached to or integral with the vapour generating device 22 rather than the cartridge 10.

1. A cartridge for a vapour generating system, the cartridge comprising:
a housing;
a closure secured to the housing;
a liquid transport element secured inside the housing; and
a heating element located inside the housing; wherein:
the heating element is attached to the closure such that removal of the closure from the housing causes displacement of the heating element; and
the heating element engages the liquid transport element such that displacement of the heating element causes damage to the liquid transport element or to the heating element.

2. The cartridge according to claim 1, wherein the heating element passes through the liquid transport element.

3. The cartridge according to claim 1, wherein the heating element wraps around the liquid transport element.

4. A-The cartridge according to claim 1, wherein the heating element comprises two electrical terminals, and wherein the closure comprises two electrodes, the terminals of the heating element being attached to the electrodes of the closure.

5. A-The cartridge according to claim 4, wherein the terminals of the heating element are welded to the electrodes of the closure.

6. A-The cartridge according to claim 4, wherein:
the two electrodes are on a distal surface of the closure;
at least one aperture extends through the closure from the distal surface to a proximal surface of the closure; and
the terminals of the heating element extend through the at least one aperture of the closure.

7. A-The cartridge according to claim 6, wherein the closure comprises two apertures formed respectively in the two electrodes; and wherein the two terminals of the heating element extend respectively through the two apertures.

8. The cartridge according to claim 1, wherein the housing comprises a reservoir welded to a reservoir cover.

9. The cartridge according to claim 8, wherein the closure of the cartridge is secured to the reservoir cover.

10. A vapour generating system comprising a vapour generating device and the cartridge according to claim 1, the cartridge being releasably coupled to the vapour generating device.

11. A method of manufacturing a cartridge for a vapour generating system, the method comprising the steps of:
engaging a heating element with a liquid transport element;
securing the liquid transport element inside a housing and locating the heating element inside the housing such that displacement of the heating element must cause damage to the liquid transport element or to the heating element;
securing a closure to the housing; and
attaching the heating element to the closure such that removal of the closure from the housing causes displacement of the heating element.

12. The method according to claim 11, wherein:
the heating element comprises two electrical terminals;
the closure comprises two electrodes on a distal surface of the closure and at least one aperture that extends through the closure from the distal surface to a proximal surface of the closure; and
the step of attaching the heating element to the closure comprises passing the terminals of the heating element through the at least one aperture in the closure and attaching the two terminals respectively to the two electrodes.

13. The method according to claim 12, wherein the step of attaching the terminals to the electrodes comprises laser welding.

14. The method according to claim 12, further comprising a preliminary step of forming the closure by insert moulding at least a part of the closure around the two electrodes.

15. The method according to claim 11, wherein:
the housing comprises a reservoir and a reservoir cover; and
the step of locating the heating element inside the housing comprises locating the heating element inside the reservoir, followed by ultrasonically welding the reservoir cover to the reservoir.
